(19) United States
(12) Patent Application Publication
(10) Pub. No.: US 2022/0220325 A1
(43) Pub. Date: Jul. 14, 2022

(54) UV CURABLE PIGMENT DISPERSION RESIN AND METHODS OF MAKING THEREOF

(71) Applicant: BASF SE, Ludwigshafen am Rhein (DE)

(72) Inventor: Paul E. SHARE, Ann Arbor, MI (US)

(21) Appl. No.: 17/617,434

(22) PCT Filed: Jun. 12, 2020
(86) PCT No.: PCT/EP2020/066275

§ 371 Date: Dec. 8, 2021

Related U.S. Application Data
(60) Provisional application No. 62/861,030, filed on Jun. 13, 2019.

(51) Int. Cl. C09D 11/101; C09D 11/326; C09D 11/107

(52) U.S. Cl. CPC C09D 11/101; B33Y 70/00; C09D 11/107; C09D 11/326

(57) ABSTRACT

The present technology provides compositions that include a UV curable resin dispersion that include a branched C₆-C₂₀ alkyl di-(meth)acrylate ester monomer and at least about 15 wt. % of one or more non-white pigments. The present technology also provides compositions that include a UV curable resin dispersion that include a branched C₆-C₂₀ alkyl di-(meth)acrylate ester monomer and at least about 35 wt. % of one or more white pigments. The compositions may be in the form of an energy curable composition. The compositions may be useful for flexographic printing, ink jet printing, and 3D printing applications.

### TECHNICAL FIELD

The present technology relates generally to the field of dispersion resins, and more specifically, to UV curable pigment dispersion resins suitable for use in ink jet, flexographic, and three-dimensional (3D) printing, and methods of making thereof.

### BACKGROUND

There is a general need for resins having low viscosity and good pigment dispersing properties for UV curable inks for use in printing techniques, such as flexographic, ink jet, and/or 3D printing technologies. While this may be obtained using inexpensive low molecular weight monomers such as 1,6 hexanediol acrylate, a challenge with using such materials is the high odor production due to low molecular weight, volatility, and high draize values. An increase in the backbone chain length of the polymerized monomers leads to crystallinity and slower viscosity.

Additive manufacturing, also referred to as 3D printing provides the promise of creativity, ingenuity and novel achievements with respect to design and manufacturing. The technology is attractive in that it enables users to design and produce objects having a high level of complexity with pinpoint accuracy. Although the technology has been successful in inspiring users to create a variety of objects, the output has generally been limited to prototypes, replacement parts and trinkets. Often times the resulting objects are fragile, display low resolution, and are expensive to produce at a micro or macro level. Other issues associated with 3D printed materials include low environmental stability resulting in yellowing, low resistance to moisture and solvents contributing to object swelling and plasticization.

Currently available ceramic photo resin formulations consist of a ceramic blend, photo curable resin, a photoinitiator, a dispersant agent and a rheology modifier. Such formulations are usually used with UV light enabled 3D printing applications for example in the investment casting industry. One significant drawback of currently available formulations is overwhelming light scattering and deep light penetration yielding lower accuracy and precision of the built parts. Additional problems include poor stability against sedimentation and poor layer-to-layer adhesion leading to delamination. What is needed is the development of improved formulations having better control of UV light penetration, layer-to-layer adhesion and print accuracy.

Accordingly, there remains an opportunity to provide improved composition materials, such as resins, for use in connection with additive manufacturing and/or 3D printing. There also remains an opportunity to provide improved materials that enable the production of small and large format objects. Furthermore, there remains an opportunity to provide novel and productive compositions that are cost-effective and have improved utility and enhanced material functionality.

### SUMMARY

In a first aspect, the present technology provides a composition that includes a UV curable resin dispersion that includes a branched C₆-C₂₀ alkyl di-(meth)acrylate ester monomer and a non-white pigment; where the composition comprises at least about 15 wt. % of the non-white pigment, based on total weight of the composition.

In another aspect, the present technology provides a composition that includes a UV curable resin dispersion comprising a branched C₆-C₂₀ alkyl di-(meth)acrylate ester monomer and a white pigment, wherein the composition includes at least about 35 wt. % of the white pigment, based on total weight of the composition.

In a related aspect, the present technology provides a method for producing a composition as described herein in any embodiment, where the method includes: combining the branched C₆-C₂₀ alkyl di-(meth)acrylate ester monomer and one or more non-white pigments to produce the UV curable resin dispersion; combining the UV curable resin dispersion with the one or more ethylenically unsaturated UV curable monomers or oligomers and optionally a photoinitiator.

In another aspect, the present technology provides a method for producing a composition as described herein in any embodiment herein, where the method includes: combining the branched C₆-C₂₀ alkyl di-(meth)acrylate ester monomer and the white pigment to produce the UV curable resin dispersion; combining the UV curable resin dispersion with the one or more ethylenically unsaturated UV curable monomers or oligomers and optionally a photoinitiator.

In a related aspect, the present technology provides an article that includes one or more coatings of a cured energy curable composition.

In another aspect, the present technology provides a method of obtaining said article comprising applying one or more successive layers of the energy curable composition as described herein in any embodiment to fabricate the article; and irradiating the successive layers with UV irradiation.

In another related aspect, the present technology provides a 3D article that includes a cured energy curable composition as described herein in any embodiment.

In another aspect, the present technology provides a method of obtaining said 3D article that includes applying one or more successive layers of the energy curable composition as described herein in any embodiment to fabricate the 3D article; and irradiating the successive layers with UV irradiation.

### BRIEF DESCRIPTION OF THE DRAWINGS

FIG. 1 shows a graphical illustration of the volatility of exemplary pigment dispersion resin according to the present technology.

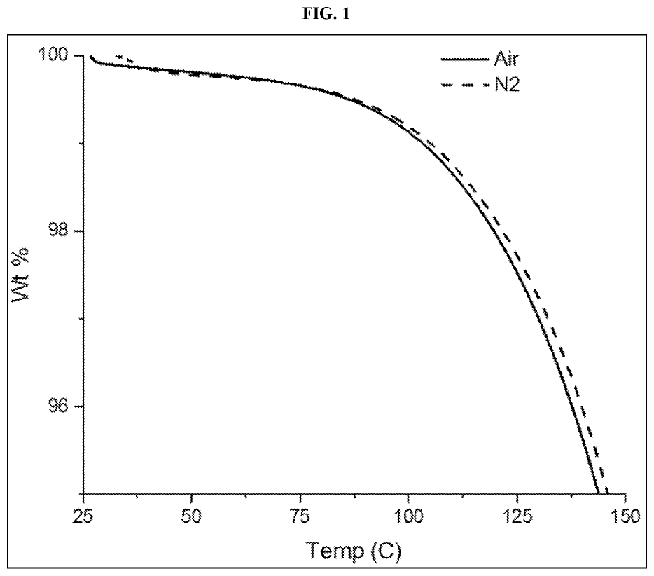

FIG. 2 shows a graphical illustration of viscosity (cP) as a function of shear rate (s⁻¹) for comparative pigment dispersion resins that include Polyester A and Polyester B, respectively, and an exemplary pigment dispersion resins according to the present technology.

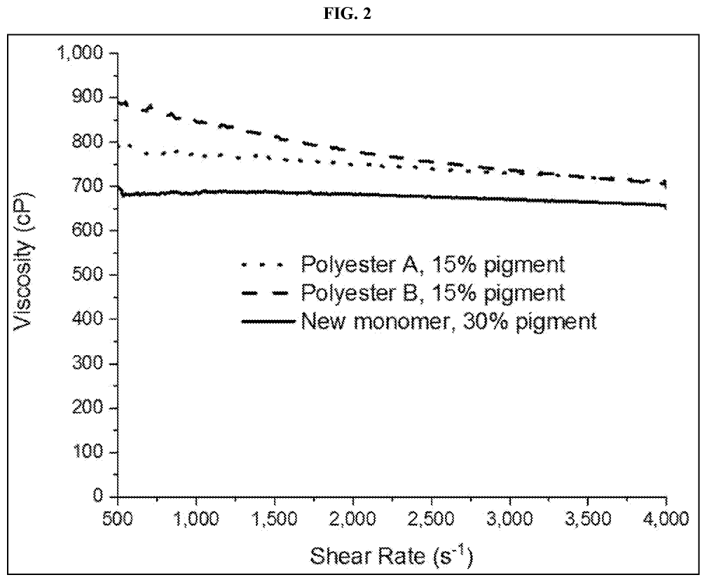

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, the term “alkyl” refers to a branched or unbranched acyclic hydrocarbon chain radical consisting solely of carbon and hydrogen atoms, containing no unsaturation, having from one to twenty carbon atoms (e.g., C₁-C₂₀ alkyl). In certain embodiments, an alkyl comprises one to fifteen carbon atoms (e.g., C₁-C₁₅ alkyl). In certain embodiments, an alkyl comprises one to thirteen carbon atoms (e.g., C₁-C₁₃ alkyl). In certain embodiments, an alkyl comprises one to eight carbon atoms (e.g., C₁-C₈ alkyl). In certain embodiments, an alkyl comprises one to six carbon atoms (e.g., C₁-C₆ alkyl). In certain embodiments, an alkyl comprises one to three carbon atoms (e.g., C₁-C₃ alkyl). In other embodiments, an alkyl comprises five to fifteen carbon atoms (e.g., C₅-C₁₅ alkyl). In other embodiments, an alkyl comprises five to eight carbon atoms (e.g., C₅-C₈ alkyl). The alkyl is attached to the rest of the molecule by a single bond, for example, methyl (Me), ethyl (Et), n-propyl, 1-methylethyl (iso-propyl), n-butyl, n-pentyl, 1,1-dimethylethyl (t-butyl), 3-methylhexyl, 2-methylhexyl, and the like. In some embodiments, an alkyl group is optionally substituted by one or more of the following substituents: halo, cyano, nitro, oxo, thioxo, —OR^{a}, —SR^{a}, —OC(O)—R^{b}, —N(R^{a})₂, —C(O)R^{a}, —C(O)OR^{a}, —C(O)N(R^{a})₂, —N(R^{a})C(O)OR^{a}, —N(R^{a})C(O)R^{a}, N(R^{a})S(O)₂R^{b}, —S(O)₂OR^{a} and —S(O)₂N(R^{a})₂, where each R^{a} is independently hydrogen, alkyl, fluoroalkyl, carbocyclyl, aryl, heterocyclyl, or heteroaryl and each R^{b} is independently alkyl, fluoroalkyl, carbocyclyl, carbocyclylalkyl, aryl, aralkyl, heterocyclyl, or heteroaryl. Examples of branched alkyl groups include, but are not limited to, isopropyl, iso-butyl, sec-butyl, tert-butyl, neopentyl, isopentyl, and 2,2 dimethylpropyl groups. In general, alkyl groups may include in addition to those listed above, but are not limited to, 2-pentyl, 2-methylbutyl, 3-methylbutyl, 1,2-dimethylpropyl, 1,1-dimethylpropyl, 2,2-dimethylpropyl, 1-ethylpropyl, 2-hexyl, 2-methylpentyl, 3-methylpentyl, 4-methylpentyl, 1,2-dimethylbutyl, 1,3-dimethylbutyl, 2,3-dimethylbutyl, 1,1-dimethylbutyl, 2,2-dimethylbutyl, 3,3-dimethylbutyl, 1,1,2-trimethylpropyl, 1,2,2-trimethylpropyl, 1-ethylbutyl, 2-ethylbutyl, 1-ethyl-2-methylpropyl, 2-heptyl, 3-heptyl, 2-ethylpentyl, 1-propylbutyl, 2-ethylhexyl, 2-propylheptyl, 1,1,3,3-tetramethylbutyl, nonyl, decyl, n-undecyl, n-dodecyl, n-tridecyl, iso-tridecyl, n-tetradecyl, n-hexadecyl, n-octadecyl, n-eicosyl, and the like.

Groups described herein having two or more points of attachment (i.e., divalent, trivalent, or polyvalent) within the compound of the present technology are designated by use of the suffix, “ene.” For example, divalent alkyl groups are alkylene groups, divalent aryl groups are arylene groups, divalent heteroaryl groups are divalent heteroarylene groups, and so forth. Substituted groups having a single point of attachment to the compound of the present technology are not referred to using the “ene” designation.

As used herein, “alkylene” refers to a divalent alkyl group, typically having from 2 to 20 carbon atoms, or from 2 to 12 carbon atoms, or in some embodiments, from 2 to 8 carbon atoms. Alkylene groups may be substituted or unsubstituted. Alkylene groups may be straight chain or branched as described herein in any embodiment. Examples of straight chain alkylene groups include methylene, ethylene, n-propylene, n-butylene, n-pentylene n-hexylene, n-heptylene, and n-octylene groups. Representative alkyl groups may be substituted one or more times with, for example, amino, thio, hydroxyl, cyano, alkoxy, and/or halo groups such as F, Cl, Br, and I.

In general, the term “substituted,” unless specifically defined differently, refers to an alkyl, alkenyl, alkynyl, aryl, or ether group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like. For some groups, substituted may provide for attachment of an alkyl group to another defined group, such as a cycloalkyl group.

As used herein, the term (meth)acrylic or (meth)acrylate refers to acrylic or methacrylic acid, esters or acrylic or methacrylic acid, and salts, amides, and other suitable derivatives of acrylic or methacrylic acid, and mixtures thereof.

As used herein, the term “energy curable” refers to compositions that may undergo light-activated cross-linking of monomers or oligomers upon exposure to an energy source, such as a mercury lamp, a light emitting diode (LED), electron beam (EB), or solar radiation. Advantageously, the composition may be UV-cured by an actinic light source, such as UV-light provided by a high-voltage mercury bulb, a medium-voltage mercury bulb, a xenon bulb, a carbon arc lamp, a metal halide bulb, a UV-LED lamp, a UV laser, such as a semi-conductor laser or an eximer laser, or sunlight.

Flexographic printing, ink jet printing, and 3D printing techniques are generally known to a person of skill in the art. As used herein, the term “flexographic printing” generally refers to techniques involving the transfer of an ink composition (such as energy curable ink compositions as described herein) flexographic printing plates where the ink composition is then transferred to a plastic film, foil, or paper which is to be printed. As used herein, the term “ink jet printing” generally refers to techniques involving deposition of an ink composition (such as energy curable ink compositions as described herein) to a substrate (e.g., paper, plastic, foil, etc.) in controlled patterns of closely spaced ink droplets.

As used herein, the term “3D printing” refers to any of various processes in which material is joined or solidified under computer control to create a three-dimensional article, with material being added together (cured or molded together). Unlike material removed from a stock in conventional machining processes, 3D printing builds a three-dimensional article using digital model data from a 3D model or another electronic data source such as computer-aided design (CAD) model or Additive Manufacturing File (AMF) usually by successively adding material layer by layer. 3D printing is associated with both rapid prototyping and additive manufacturing (AM). 3D printed articles can be of almost any shape or geometry. As used herein, 3D printing includes stereolithography (SLA), digital light processing (DLP), and vat photo polymerization (e.g., continuous liquid interface production (CLIP)). In any embodiment herein, the 3D printed article may be produced by any means known to a person of skill in the art including loading data into a computer that controls a light source that traces a pattern or projects an image of a cross section through an energy curable composition in a vat, solidifying a thin layer of the energy curable composition corresponding to the cross section. The solidified layer (i.e., cured layer) is recoated with the energy curable composition and the light source traces another cross section or projects an image of a layer or its parts to harden another layer of the energy curable composition adjacent to the previous layer (e.g., on top or underneath for vat photo polymerization including SLP and DLP). The process is repeated layer by layer until the 3D article is completed. When initially formed, the 3D article is, in general, fully or partially cured, and is called a “green model”. In any embodiment herein, the green model may be manipulated through post-processing steps including post-printing electromagnetic radiation, sonication, vibration, washing, cleaning, debris management, support removal, post curing, baking, sintering, annealing, or any combination of two or more thereof. Various light sources may be used for 3D printing, including but not limited to, UV light, LED, a light bulb, a laser and/or a digital light projector (DLP) (i.e., image projection).

In any embodiment herein, the 3D printing method may be additive manufacturing. As used herein, the term “additive manufacturing” refers to a process by which digital 3D design data is used to build up an article through chemical or physical transformation.

The inventors of the present technology discovered that a highly branched resin with an ester linkage in its backbone provides low viscosity and high pigment wetting due to its backbone. Without being bound by theory, it is believed that the low viscosity and high pigment wetting are due to low surface tension and low volatility. The low viscosity and highly branched structure are also advantageous in either pigmented or non-pigmented 3D printing formulations in reducing moisture sensitivity.

Compared with alternatives such as 1,6 hexanediol di-(meth)acrylate, the material has low volatility and expected to have corresponding lower draize and better worker exposure profile. Alternatives such as 1,6 hexanediol di-(meth)acrylate also do not have comparable pigment dispersing properties, so they are more likely to be used in the letdown portion of a flexographic, ink jet, or 3D printable ink composition. The inventors of the present technology surprisingly discovered the compositions of the present technology can achieve higher pigment loadings compared with alternative monomeric or oligomeric UV curable dispersion resins.

### Energy Curable Compositions

In a first aspect, a composition is provided that includes a UV curable resin dispersion that includes a branched C₆-C₂₀ alkyl di-(meth)acrylate ester monomer and a non-white pigment; where the composition comprises at least about 15 wt. % of the non-white pigment, based on total weight of the composition.

In any embodiment herein, the branched alkyl di-(meth)acrylate ester monomer is a branched C₆-C₁₅alkyl di-(meth)acrylate ester monomer. For example, in any embodiment herein, the branched alkyl di-(meth)acrylate ester monomer may be a branched C₉-C₁₁ alkyl di-(meth)acrylate ester monomer. In any embodiment herein, the branched alkyl di-(meth)acrylate ester monomer may be a di-(meth)acrylate ester of hydroxypivalic acid neopentyl glycol ester. In any embodiment, the branched di-(meth)acrylate ester monomer may not include a dipentaerythritol group.

In any embodiment herein, the UV curable resin dispersion may include at least about 10 wt. % of the branched C₆-C₂₀ alkyl di-(meth)acrylate ester monomer, based on total weight of the UV curable resin dispersion. For example, in any embodiment herein, the UV curable resin dispersion may include about 10 wt. % to about 50 wt. % of the branched C₆-C₂₉ alkyl di-(meth)acrylate ester monomer, based on total weight of the UV curable resin dispersion. Suitable amounts in any embodiment herein may include about 10 wt. %, about 15 wt. %, about 20 wt. %, about 25 wt. %, about 30 wt. %, about 35 wt. %, about 40 wt. %, about 45 wt. %, about 50 wt. %, or any range including and/or between any two of the preceding values. For example, in any embodiment herein, the UV curable resin dispersion comprises about 10 wt. % to about 50 wt. %, about 15 wt. % to about 45 wt. %, about 20 wt. % to about 40 wt. %, or about 25 wt. % to about 35 wt. % of the branched C₆-C₂₀ alkyl di-(meth)acrylate ester monomer, based on total weight of the UV curable resin dispersion.

As noted above, the UV curable resin dispersion may include a non-white pigment. In any embodiment herein, the UV curable resin dispersion may include from about 35 wt. % to about 65 wt. % of the non-white pigment, based on total weight of the UV curable resin dispersion. Suitable amounts in any embodiment herein may include, but are not limited to, about 35 wt. %, about 40 wt. %, about 45 wt. %, about 50 wt. %, about 55 wt. %, about 60 wt. %, about 65 wt. %, or any range including and/or in between any two of the preceding values of the non-white pigment based on the total weight of the UV curable resin dispersion. For example, in any embodiment herein, the UV curable dispersion may include from about 35 wt. % to about 65 wt. %, about 40 wt. % to about 60 wt. %, or about 45 wt. % to about 55 wt. % of non-white pigment based on the total weight of the UV curable resin dispersion.

In any embodiment herein, the composition may include at least about 15 wt. % of the non-white pigment based on the total weight of the composition. In any embodiment herein, the composition may include at least about 20 wt. % of the non-white pigment, based on the total weight of the composition. For example, in any embodiment herein, the composition may include from about 15 wt. % to about 60 wt. %, about 15 wt. % to about 50 wt. %, about 25 wt. % to about 35 wt. %, about 20 wt. % to about 30 wt. % of the non-white pigment, based on the total weight of the composition. Suitable amounts in any embodiment herein may include, but are not limited to, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, or any range including and/or in between any two of the preceding values.

In any embodiment herein, the non-white pigments may include, but are not limited to, inorganic pigments, organic pigments, or a mixture of any two or more thereof. For examples, in any embodiment herein, the non-white pigments may include bright pigments (e.g., aluminum powder, copper powder, nickel powder, stainless steel powder, chromium powder, micaceous iron oxide, titanium dioxide-coated mica powder, iron oxide-coated mica powder, and bright graphite; organic red pigments (e.g., Pink EB, azo- and quinacridone-derived pigments); organic blue pigments (e.g., cyanin blue and cyanin green); organic yellow pigments (e.g., benzimidazolone-, isoindolin- and quinophthalone-derived pigments); inorganic colored pigments (e.g., titanium yellow, iron red, carbon black, chrome yellow, iron oxide and various calcined pigments), or mixtures of two or more thereof. Other examples of suitable pigments may include, but are not limited to, Raven 7000, Raven 5750, Raven 5250, Raven 5000 ULTRAII, Raven 3500, Raven 2000, Raven 1500, Raven 1250, Raven 1200, Raven 1190 ULTRAII, Raven 1170, Raven 1255, Raven 1080 and Raven 1060 (commercially available from Columbian Carbon Co.); Regal400R, Regal330R, Regal660R, Mogul L, Black Pearls L, Monarch 700, Monarch 800, Monarch 880, Monarch 900, Monarch 1000, Monarch 1100, Monarch 1300 and Monarch 1400 (commercially available from Cabot Co.); Color Black FW1, Color Black FW2, Color Black FW2V, Color Black 18, Color Black FW200, Color Black S150, Color Black S160, Color Black S170, Printex35, PrintexU, PrintexV, Printex140U, Printex140V, Special Black 6, Special Black 5, Special Black 4A and Special Black 4 (commercially available from Degussa Co.); No. 25, No. 33, No. 40, No. 47, No. 52, No. 900, No. 2300, MCF-88, MA600, MA7, MA8 and MA100 (commercially available from Mitsubishi Chemical Corporation); cyanic color pigment like C.I. Pigment Blue-1, C.I. Pigment Blue-2, C.I. Pigment Blue-3, C.I. Pigment Blue-15, C.I. Pigment Blue-15:1, C.I. Pigment Blue-15:3, C.I. Pigment Blue-15:34, Pigment Blue 15:4; C.I. Pigment Blue-16, C.I. Pigment Blue-22 and C.I. Pigment Blue-60; magenta color pigment like C.I. Pigment Red-5, C.I. Pigment Red-7, C.I. Pigment Red-12, C.I. Pigment Red-48, C.I. Pigment Red-48:1, C.I. Pigment Red-57, Pigment Red-57:1, C.I. Pigment Red-112, C.I. Pigment Red-122, C.I. Pigment Red-123, C.I. Pigment Red-146, C.I. Pigment Red-168, C.I. Pigment Red-184 and C.I. Pigment Red-202; and yellow color pigment like C.I. Pigment Yellow-1, C.I. Pigment Yellow-2, C.I. Pigment Yellow-3, C.I. Pigment Yellow-12, C.I. Pigment Yellow-13, C.I. Pigment Yellow-14, C.I. Pigment Yellow-16, C.I. Pigment Yellow-17, C.I. Pigment Yellow-73, C.I. Pigment Yellow-74, C.I. Pigment Yellow-75, C.I. Pigment Yellow-83, C.I. Pigment Yellow-93, C.I. Pigment Yellow-95, C.I. Pigment Yellow-97, C.I. Pigment Yellow-98, C.I. Pigment Yellow-114, C.I. Pigment Yellow-128, C.I. Pigment Yellow-129, C.I. Pigment Yellow-151 and C.I. Pigment Yellow-154. Suitable pigments include a wide variety of carbon black, blue, red, yellow, green, violet, and orange pigments.

In any embodiment herein, the non-white pigment may be an organic pigment or dye. Suitable organic dyes in any embodiment herein may include, but are not limited to, azo dyes, anthraquinine dyes, xanthene dyes, azine dyes, or any combination of two or more thereof. Suitable organic pigments in any embodiment herein may include, but are not limited to, Pigment Yellow Numbers 12, 13, 14, 17, 74, 83, 114, 126, 127, 174, 188; Pigment Red Numbers 2, 22, 223, 48:1, 48:2, 52, 52:1, 53, 57:1, 112, 122, 166, 170, 184, 202, 266, 269; Pigment Orange Numbers 5, 16, 34, 36; Pigment Blue Numbers 15, 15:3, 15:4; Pigment Violet Numbers 3, 23, 27; Pigment Green Number 7; or combinations of any two or more thereof.

In any embodiment herein, the nonwhite-pigment may be an inorganic pigment or dye. Suitable inorganic pigments or dyes in any embodiment herein may include, but are not limited to, iron oxides, chromium oxides, ferric ammonium ferrocyanides, ferric oxide blacks, Pigment Black Number 7, or combinations of any two or more thereof. In any embodiment herein, the non-white pigments may include any of the aforementioned organic pigments, organic dyes, inorganic pigments, inorganic dyes, or combinations of any two or more thereof.

In any embodiment herein, the UV curable resin dispersion may further include a dispersant. The type and class of dispersant may include any dispersant compatible with the UV curable resin dispersion as described herein in any embodiment and known to a person having ordinary skill in the art. In any embodiment herein, the dispersant may be a surfactant or a polymeric dispersant. For example, in any embodiment herein, the dispersant may have a molecular weight of at least about 100 g/mol. For example, in any embodiment herein, the dispersant may have a molecular weight from about 100 g/mol to about 5,000,000 g/mol. Suitable molecular weights in any embodiment herein may include, but are not limited to, about 100 g/mol to about 5,000,000 g/mol, about 500 g/mol to about 2,500,000 g/mol, about 1,000 g/mol to about 1,000,000 g/mol, about 2,000 g/mol to about 500,000 g/mol, about 3,000 g/mol to about 100,000 g/mol, about 4000 g/mol to about 50,000 g/mol, about 5000 g/mol to about 30,0000 g/mol, or any range including and/or in between any two of the preceding values.

In any embodiment herein, the dispersant may include, but is not limited to, poly(ethylene), poly(propylene), poly(butylene), poly(isobutylene), poly(isoprene), poly(acetal), poly(ethylene glycol), poly(propylene glycol), poly(butylene glycol), poly(methylmethacrylate), poly(dimethylsiloxane), poly(vinylalcohol), poly(styrene), poly(maleic anhydride), poly(ethylmethacrylate), poly(isobutylmethacrylate), poly(methacrylate), poly(butylmethacrylate), poly(n-butymethacrylate), poly(vinyl butyrate), poly(vinyl chloride), polysiloxane, or a mixture of two or more thereof. In any embodiment herein, the dispersant may be random, block, or alternating copolymers. For example, in any embodiment herein, the dispersant may be a co-polymer made from two or more different monomers, including but not limited to the monomers making up the polymers described above. Suitable co-polymers in any embodiment herein may include, but are not limited to, polyethers, polyesters, polyamides, acrylics, polystyrenes, or mixtures of any two or more thereof. In any embodiment herein, the co-polymer may be random, block, or alternating. In any embodiment herein, the co-polymer may be a polyether, such as alternating or block poly(ethylene oxide) (PEO), poly(propylene oxide) (PPO) groups.

In any embodiment, the dispersant may include acidic groups. For example, in any embodiment herein, the acidic groups may include, but are not limited to, carboxylic acids, sulfinic acids, sulfonic acids, phosphonic acids, phosphate esters, maleic anhydrides, succinic anhydride, or combinations of any two or more thereof. In any embodiment herein, the dispersant may include, but is not limited to, phosphonate, phosphate, phosphite, phosphine, phosphate ester (e.g., phosphate, phosphite, or phosphate acid), or mixtures of any two or more thereof. In any embodiment herein, the acidic group may be in the form of a salt.

In any embodiment herein, the dispersant may include, but is not limited to, dispersant from the product lines DisperByk (BYK), Solsperse (Lubrizol), Solplus (Lubrizol), Tego Dispers (Evonik), Tego Wet (Evonik), EFKA (BASF, or combinations of any two or more thereof. For example, in any embodiment herein, the dispersant may include, but is not limited to, Disperbyk 102, Disperbyk 103, Disperbyk 106, Disperbyk 107, Disperbyk 108, Disperbyk 109, Disperbyk 110, Disperbyk 111, Disperbyk 115, Disperbyk 118, Disperbyk 140, Disperbyk 142, Disperbyk 145, Disperbyk 161, Disperbyk 163, Disperbyk 164, Disperbyk 167, Disperbyk 168, Disperbyk 170, Disperbyk 171, Disperbyk 174, Disperbyk 180, Disperbyk 181, Disperbyk 182, Disperbyk 184, Disperbyk 185, Disperbyk 187, Disperbyk 190, Disperbyk 191, Disperbyk 192, Disperbyk 193, Disperbyk 194N, Disperbyk 199, Disperbyk 2000, Disperbyk 2001, Disperbyk 2008, Disperbyk 2009, Disperbyk 2010, Disperbyk 2012, Disperbyk 2013, Disperbyk 2015, Disperbyk 2022, Disperbyk 2025, Disperbyk 2050, Disperbyk 2055, Disperbyk 2060, Disperbyk 2061, Disperbyk 2096, Disperbyk 2117, Disperbyk 2118, Disperbyk 2150, Disperbyk 2151, Disperbyk 2152, Disperbyk 2155, Disperbyk 2163, Disperbyk 2164, Disperbyk 2200, Tego Dispers 630, Tego Dispers 650, Tego Dispers 652, Tego Dispers 653, Tego Dispers 656, Tego Dispers 660 C, Tego Dispers 670, Tego Dispers 671, Tego Dispers 672, Tego Dispers 685, Tego Dispers 688, Tego Dispers 700, Tego Dispers 710, Tego Dispers 735 W, Tego Dispers 740 W, Tego Dispers 745 W, Tego Dispers 750 W, Tego Dispers 752 W, Tego Dispers 755 W, Tego Dispers 757 W, Tego Dispers 760 W, Tego Dispers 761 W, Tego Wet 240, Tego Wet 250, Tego Wet 251, Tego Wet 260, Tego Wet 265, Tego Wet 270, Tego Wet 280, Tego Wet 500, Tego Wet 505, Tego Wet 510, Tego Wet KL245, EFKA 6220, EFKA 6225, or a combination of any two or more thereof.

In any embodiment herein, the UV curable resin dispersion may include from about 0.01 wt. % to about 10 wt. % of the dispersant, based on the total weight of the UV curable resin dispersion. For example, in any embodiment herein, the UV curable resin dispersion may include from about 0.01 wt. % to about 10 wt. %, about 0.1 wt. % to about 10 wt. %, about 0.5 wt. % to about 10 wt. %, about 1 wt. % to about 10 wt. %, about 1 wt. % to about 6 wt. %, about 2.5 wt. % to about 5.5 wt. %, about 5 wt. % to about 10 wt. % of the dispersant. Suitable amounts in any embodiment herein may include, but are not limited to, about 0.01 wt. %, about 0.05 wt. %, about 0.1 wt. %, about 0.5 wt. %, about 1 wt. %, about 1.5 wt. %, about 2 wt. %, about 2.5 wt. %, about 3 wt. %, about 3.5 wt. %, about 4 wt. %, about 4.5 wt. %, about 5 wt. %, about 5.5 wt. %, about 6 wt. %, about 6.5 wt. %, about 7 wt. %, about 7.5 wt. %, about 8 wt. %, about 8.5 wt. %, about 9 wt. %, about 9.5 wt. %, about 10 wt. %, or any range including and/or in between any two of the preceding values.

In any embodiment herein, the composition may include from about 30 wt. % to about 70 wt. % of the UV curable resin dispersion, based on total weight of the composition. For example, in any embodiment herein, the composition may include from about 30 wt. % to about 70 wt. %, about 35 wt. % to about 65 wt. %, about 40 wt. % to about 60 wt. %, about 45 wt. % to about 55 wt. % of the UV curable resin dispersion, based on the total weight of the composition. Suitable amounts in any embodiment herein may include, but are not limited to, about 30 wt. %, about 35 wt. %, about 40 wt. %, about 45 wt. %, about 50 wt. %, about 55 wt. %, about 60 wt. %, about 65 wt. %, about 70 wt. %, or any range including and/or in between any two of the preceding values.

In any embodiment herein, the composition may be an energy curable composition that further includes one or more ethylenically unsaturated UV curable monomers or oligomers. In any embodiment herein, the one or more ethylenically unsaturated UV curable monomers or oligomers may be selected from Bisphenol A diglycidyl ether diacrylate, 2-(2-ethoxyethoxy) ethyl acrylate, 2-phenoxyethyl acrylate, 2-phenoxyethyl methacrylate, C₁₂/C₁₄ alkyl methacrylate, C₁₆/C₁₈ alkyl acrylate, C₁₆/C₁₈ alkyl methacrylate, caprolactone acrylate, cyclic trimethylolpropane formal acrylate, ethoxylated (4) nonyl phenol acrylate, isobornyl acrylate, isobornyl methacrylate, isodecyl acrylate, lauryl acrylate, methoxy polyethylene glycol (350) monomethacrylate, octyldecyl acrylate, polypropylene glycol monomethacrylate, stearyl acrylate, tetrahydrofurfuryl acrylate, tetrahydrofurfuryl methacrylate, tridecyl acrylate, 1,3-butylene glycol dimethacrylate, 1,4-butanediol dimethacrylate, 1,6 hexanediol diacrylate, 1,6 hexanediol dimethacrylate, alkoxylated diacrylate, diethylene glycol dimethacrylate, dipropylene glycol diacrylate, esterdiol diacrylate, ethoxylated (10) bisphenol a diacrylate, ethoxylated (2) bisphenol a dimethacrylate, ethoxylated (3) bisphenol a diacrylate, ethoxylated (3) bisphenol a dimethacrylate, ethoxylated (4) bisphenol a diacrylate, ethoxylated (4) bisphenol a dimethacrylate, ethoxylated bisphenol a dimethacrylate, ethoxylated (10) bisphenol dimethacrylate, ethylene glycol dimethacrylate, polyethylene glycol (200) diacrylate polyethylene glycol (400) diacrylate, polyethylene glycol (400) dimethacrylate, polyethylene glycol (600) diacrylate, polyethylene glycol (600) dimethacrylate, polyethylene glycol 400 diacrylate, polyethylene glycol dimethacrylate, propoxylated (2) neopentyl glycol diacrylate, tetraethylene glycol diacrylate, tricyclodecane dimethanol diacrylate, tricyclodecanedimethanol dimethacrylate, triethylene glycol diacrylate, triethylene glycol dimethacrylate, tripropylene glycol diacrylate, ethoxylated (15) trimethylolpropane triacrylate, ethoxylated (3) trimethylolpropane triacrylate, ethoxylated (6) trimethylolpropane triacrylate, ethoxylated (9) trimethylolpropane triacrylate, ethoxylated 5 pentaerythritol triacrylate, ethoxylated (20) trimethylolpropane triacrylate, propoxylated (5.5) glyceryl triacrylate pentaerythritol triacrylate, propoxylated (3) glyceryl triacrylate, propoxylated (3) trimethylolpropane triacrylate, trimethylolpropane triacrylate, trimethylolpropane trimethacrylate, tris (2-hydroxy ethyl) isocyanurate triacrylate, di-trimethylolpropane tetraacrylate, dipentaerythritol pentaacrylate, and pentaerythritol tetraacrylate, or combinations of two or more thereof. In any embodiment herein, the one or more ethylenically unsaturated UV curable monomers or oligomers may be selected from ethoxylated (15) trimethylolpropane triacrylate, ethoxylated (3) trimethylolpropane triacrylate, ethoxylated (6) trimethylolpropane triacrylate, ethoxylated (9) trimethylolpropane triacrylate, Bisphenol A diglycidyl ether diacrylate, or a mixture of two or more thereof.

In any embodiment herein, the composition may include from about 5 wt. % to about 60 wt. % of the one or more ethylenically unsaturated UV curable monomer or oligomer, based on total weight of the composition. For example, in any embodiment herein, the composition may include from about 5 wt. % to about 60 wt. %, about 10 wt. % to about 50 wt. %, about 10 wt. % to about 40 wt. %, about 10 wt. % to about 20 wt. %, about 15 wt. % to about 35 wt. % of the one or more ethylenically unsaturated UV curable monomers or oligomers, based on the total weight of the composition. Suitable amounts in any embodiment herein may include, but are not limited to, about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, or any range including and/or in between any two of the preceding values.

The composition, as described in any embodiment herein, may further include a photoinitiator. Suitable photoinitiators in any embodiment herein may include, but are not limited to, an aryl ketone type photoinitiator (e.g., an acetophenone, a benzophenone, an alkylaminobenzophenone, a benzyl, a benzoin, a benzoin ether, a benzoin dimethyl ketal, a benzoyl benzoate, 1-hydroxycyclohexyl phenyl ketone or an a-acyloxime ester), a sulfur-containing photopolymerization initiator (e.g., a sulfide or a thioxanthone), an acylphosphine oxide (e.g., an acyldiarylphosphine oxide), or the like and mixtures of two or more thereof.

In any embodiment herein, the composition may include from about 0.1 wt. % to about 10 wt. % of the photoinitiator, based on total weight of the composition. For example, in any embodiment herein, the composition may include from about 0.1 wt. % to about 10 wt. %, about 0.5 wt. % to about 10 wt. %, about 1 wt. % to about 10 wt. %, about 1 wt. % to about 5 wt. % of the photoinitiator, based on the total weight of the composition. Suitable amounts in any embodiment herein may include, but are not limited to, about 0.01 wt. %, about 0.05 wt. %, about 0.1 wt. %, about 0.5 wt. %, about 1 wt. %, about 1.5 wt. %, about 2 wt. %, about 2.5 wt. %, about 3 wt. %, about 3.5 wt. %, about 4 wt. %, about 4.5 wt. %, about 5 wt. %, about 5.5 wt. %, about 6 wt. %, about 6.5 wt. %, about 7 wt. %, about 7.5 wt. %, about 8 wt. %, about 8.5 wt. %, about 9 wt. %, about 9.5 wt. %, about 10 wt. %, or any range including and/or in between any two of the preceding values.

In any embodiment herein, the composition may have a viscosity of about 5 cP to about 1000 cP. For example, in any embodiment herein, the viscosity may be about 5 cP to about 1000 cP, about 10 cP to about 50 cP, about 15 cP to about 30 cP, about 20 cP to about 25 cP, about 50 cP to about 1000 cP, about 300 cP to about 1000 cP, or about 600 cP to about 1000. Suitable amounts in any embodiment herein may include, but are not limited to, about 5 cP, about 10 cP, about 20 cP, about 30 cP, about 40 cP, about 50 cP, about 60 cP, about 70 cP, about 80 cP, about 90 cP, about 100 cP, about 150 cP, about 200 cP, about 250 cP, about 300 cP, about 350 cP, about 400 cP, about 450 cP, about 500 cP, about 550 cP, about 600 cP, about 650 cP, about 700 cP, about 750 cP, about 800 cP, about 850 cP, about 900 cP, about 950 cP, about 1000 cP, or any range including and/or in between any two of the preceding values. In any embodiment herein, the composition may have a viscosity of about 5 cP to about 45 cP, about 5 cP to about 35 cP, about 15 cP to about 25 cP. In any embodiment herein, the composition may have a viscosity of about 500 cP to about 900 cP or about 600 cP to about 800 cP.

The composition of the present technology, as described herein in any embodiment, may be configured for use in flexographic printing, ink jet printing, or three-dimensional (3D) printing.

In any embodiment herein, the composition may be UV curable.

In another aspect, a composition is provided that includes a UV curable resin dispersion comprising a branched C₆-C₂₀ alkyl di-(meth)acrylate ester monomer and a white pigment, wherein the composition includes at least about 35 wt. % of the white pigment, based on total weight of the composition.

In any embodiment herein, the UV curable resin dispersion may include at least about 10 wt. % of the branched C₆-C₂₀ alkyl di-(meth)acrylate ester monomer, based on total weight of the UV curable resin dispersion. For example, in any embodiment herein, the UV curable resin dispersion may include about 10 wt. % to about 50 wt. % of the branched C₆-C₂₀ alkyl di-(meth)acrylate ester monomer, based on total weight of the UV curable resin dispersion. Suitable amounts in any embodiment herein may include about 10 wt. %, about 15 wt. %, about 20 wt. %, about 25 wt. %, about 30 wt. %, about 35 wt. %, about 40 wt. %, about 45 wt. %, about 50 wt. %, or any range including and/or between any two of the preceding values. For example, in any embodiment herein, the UV curable resin dispersion comprises about 10 wt. % to about 50 wt. %, about 15 wt. % to about 45 wt. %, about 20 wt. % to about 40 wt. %, or about 25 wt. % to about 35 wt. % of the branched C₆-C₂₀ alkyl di-(meth)acrylate ester monomer, based on total weight of the UV curable resin dispersion.

In any embodiment herein, the UV curable resin dispersion may include from about 35 wt. % to about 70 wt. % of the white pigment, based on total weight of the UV curable resin dispersion. For example, in any embodiment herein, the UV curable resin dispersion may include from about 35 wt. % to about 70 wt. %, about 35 wt. % to about 65 wt. %, about 35 wt. % to about 55 wt. %, or about 35 wt. % to about 45 wt. % of the white pigment, based on total weight of the UV curable resin dispersion. Suitable amounts in any embodiment herein may include, but are not limited to, about 35 wt. %, about 40 wt. %, about 45 wt. %, about 50 wt. %, about 55 wt. %, about 60 wt. %, about 65 wt. %, about 70 wt. %, or any range including and/or in between any two of the preceding values.

In any embodiment herein, the composition may include at least about 35 wt. % of the white pigment, based on the total weight of the composition. In any embodiment herein, the composition may include at least about 40 wt. % of the white pigment, based on the total weight of the composition. For example, in any embodiment herein, the composition may include from about 35 wt. % to about 70 wt. %, about 35 wt. % to about 65 wt. %, about 35 wt. % to about 55 wt. %, about 35 wt. % to about 45 wt. %, about 40 wt. % to about 60 wt. %, or about 40 wt. % to about 50 wt. % of the white pigment based on the total weight of the composition. Suitable amounts in any embodiment herein may include, but are not limited to, about 35 wt. %, about 40 wt. %, about 45 wt. %, about 50 wt. %, about 55 wt. %, about 60 wt. %, about 65 wt. %, about 70 wt. %, or any range including and/or in between any two of the preceding values.

In any embodiment herein, the white pigments may include, but are not limited to, a pigment with a refractive index greater than about 1.60. For example, in any embodiment herein, the white pigment may be a pigment with a refractive index of greater than about 1.60, greater than about 2.00, greater than about 2.25, greater than about 2.50, greater than about 2.60, or any range including and/or in between any two of the preceding values. Suitable white pigments in any embodiment herein may include the pigments provided in the table below or mixtures of any two or more thereof:

| C.I. Number | Chemical Name | CAS RN |
|---|---|---|
| Pigment white 1 | lead hydroxide carbonate | 1319-46-6 |
| Pigment white 3 | lead sulfate | 7446-14-2 |
| Pigment white 4 | zinc oxide | 1314-13-2 |
| Pigment white 5 | lithopone | 1345-05-7 |
| Pigment white 6 | titanium dioxide | 13463-67-7 |
| Pigment white 7 | zinc sulfide | 1314-98-3 |
| Pigment white 10 | barium carbonate | 513-77-9 |
| Pigment white 11 | antimony trioxide | 1309-64-4 |
| Pigment white 12 | zirconium oxide | 1314-23-4 |
| Pigment white 14 | bismuth oxychloride | 7787-59-9 |
| Pigment white 17 | bismuth subnitrate | 1304-85-4 |
| Pigment white 18 | calcium carbonate | 471-34-1 |
| Pigment white 19 | kaolin | 1332-58-7 |
| Pigment white 21 | barium sulfate | 7727-43-7 |
| Pigment white 24 | aluminum hydroxide | 21645-51-2 |
| Pigment white 25 | calcium sulfate | 7778-18-9 |
| Pigment white 27 | silicon dioxide | 7631-86-9 |
| Pigment white 28 | calcium metasilicate | 10101-39-0 |
| Pigment white 32 | zinc phosphate cement | 7779-90-0 |

In any embodiment herein, the UV curable resin dispersion may further include a dispersant. The type and class of dispersant may include any dispersant compatible with the UV curable resin dispersion as described herein in any embodiment and known to a person having ordinary skill in the art. In any embodiment herein, the dispersant may be a surfactant or a polymeric dispersant. For example, in any embodiment herein, the dispersant may have a molecular weight of at least about 100 g/mol. For example, in any embodiment herein, the dispersant may have a molecular weight from about 100 g/mol to about 5,000,000 g/mol. Suitable molecular weights in any embodiment herein may include, but are not limited to, about 100 g/mol to about 5,000,000 g/mol, about 500 g/mol to about 2,500,000 g/mol, about 1,000 g/mol to about 1,000,000 g/mol, about 2,000 g/mol to about 500,000 g/mol, about 3,000 g/mol to about 100,000 g/mol, about 4000 g/mol to about 50,000 g/mol, about 5000 g/mol to about 30,0000 g/mol, or any range including and/or in between any two of the preceding values. In any embodiment, the dispersant has a molecular that may be less than about 100,000 g/mol, less than about 50,000 g/mol, less than about 30,000 g/mol, or any range including and/or in between any two or more of the preceding values.

In any embodiment herein, the dispersant may include, but is not limited to, poly(ethylene), poly(propylene), poly(butylene), poly(isobutylene), poly(isoprene), poly(acetal), poly(ethylene glycol), poly(propylene glycol), poly(butylene glycol), poly(methylmethacrylate), poly(dimethylsiloxane), poly(vinylalcohol), poly(styrene), poly(maleic anhydride), poly(ethylmethacrylate), poly(isobutylmethacrylate), poly(methacrylate), poly(butylmethacrylate), poly(n-butymethacrylate), poly(vinyl butyrate), poly(vinyl chloride), polysiloxane, or a mixture of two or more thereof. In any embodiment herein, the dispersant may be random, block, or alternating copolymers. For example, in any embodiment herein, the dispersant may be a co-polymer made from two or more different monomers, including but not limited to the monomers making up the polymers described above. Suitable co-polymers in any embodiment herein may include, but are not limited to, polyethers, polyesters, polyamides, acrylics, polystyrenes, or mixtures of any two or more thereof. In any embodiment herein, the co-polymer may be random, block, or alternating. In any embodiment herein, the co-polymer may be a polyether, such as alternating or block poly(ethylene oxide) (PEO), poly(propylene oxide) (PPO) groups.

In any embodiment, the dispersant may include acidic groups. For example, in any embodiment herein, the acidic groups may include, but are not limited to, carboxylic acids, sulfinic acids, sulfonic acids, phosphonic acids, phosphate esters, maleic anhydrides, succinic anhydride, or combinations of any two or more thereof. In any embodiment herein, the dispersant may include, but is not limited to, phosphonate, phosphate, phosphite, phosphine, phosphate ester (e.g., phosphate, phosphite, or phosphate acid), or mixtures of any two or more thereof. In any embodiment herein, the acidic group may be in the form of a salt.

In any embodiment herein, the dispersant may include, but is not limited to, dispersant from the product lines DisperByk (BYK), Solsperse (Lubrizol), Solplus (Lubrizol), Tego Dispers (Evonik), Tego Wet (Evonik), EFKA (BASF, or combinations of any two or more thereof. For example, in any embodiment herein, the dispersant may include, but is not limited to, Disperbyk 102, Disperbyk 103, Disperbyk 106, Disperbyk 107, Disperbyk 108, Disperbyk 109, Disperbyk 110, Disperbyk 111, Disperbyk 115, Disperbyk 118, Disperbyk 140, Disperbyk 142, Disperbyk 145, Disperbyk 161, Disperbyk 163, Disperbyk 164, Disperbyk 167, Disperbyk 168, Disperbyk 170, Disperbyk 171, Disperbyk 174, Disperbyk 180, Disperbyk 181, Disperbyk 182, Disperbyk 184, Disperbyk 185, Disperbyk 187, Disperbyk 190, Disperbyk 191, Disperbyk 192, Disperbyk 193, Disperbyk 194N, Disperbyk 199, Disperbyk 2000, Disperbyk 2001, Disperbyk 2008, Disperbyk 2009, Disperbyk 2010, Disperbyk 2012, Disperbyk 2013, Disperbyk 2015, Disperbyk 2022, Disperbyk 2025, Disperbyk 2050, Disperbyk 2055, Disperbyk 2060, Disperbyk 2061, Disperbyk 2096, Disperbyk 2117, Disperbyk 2118, Disperbyk 2150, Disperbyk 2151, Disperbyk 2152, Disperbyk 2155, Disperbyk 2163, Disperbyk 2164, Disperbyk 2200, Tego Dispers 630, Tego Dispers 650, Tego Dispers 652, Tego Dispers 653, Tego Dispers 656, Tego Dispers 660 C, Tego Dispers 670, Tego Dispers 671, Tego Dispers 672, Tego Dispers 685, Tego Dispers 688, Tego Dispers 700, Tego Dispers 710, Tego Dispers 735 W, Tego Dispers 740 W, Tego Dispers 745 W, Tego Dispers 750 W, Tego Dispers 752 W, Tego Dispers 755 W, Tego Dispers 757 W, Tego Dispers 760 W, Tego Dispers 761 W, Tego Wet 240, Tego Wet 250, Tego Wet 251, Tego Wet 260, Tego Wet 265, Tego Wet 270, Tego Wet 280, Tego Wet 500, Tego Wet 505, Tego Wet 510, Tego Wet KL245, EFKA 6220, EFKA 6225, or a combination of any two or more thereof.

In any embodiment herein, the UV curable resin dispersion may include from about 0.01 wt. % to about 10 wt. % of the dispersant, based on the total weight of the UV curable resin dispersion. For example, in any embodiment herein, the UV curable resin dispersion may include from about 0.01 wt. % to about 10 wt. %, about 0.1 wt. % to about 10 wt. %, about 0.5 wt. % to about 10 wt. %, about 1 wt. % to about 10 wt. %, about 1 wt. % to about 6 wt. %, about 2.5 wt. % to about 5.5 wt. %, about 5 wt. % to about 10 wt. % of the dispersant. Suitable amounts in any embodiment herein may include, but are not limited to, about 0.01 wt. %, about 0.05 wt. %, about 0.1 wt. %, about 0.5 wt. %, about 1 wt. %, about 1.5 wt. %, about 2 wt. %, about 2.5 wt. %, about 3 wt. %, about 3.5 wt. %, about 4 wt. %, about 4.5 wt. %, about 5 wt. %, about 5.5 wt. %, about 6 wt. %, about 6.5 wt. %, about 7 wt. %, about 7.5 wt. %, about 8 wt. %, about 8.5 wt. %, about 9 wt. %, about 9.5 wt. %, about 10 wt. %, or any range including and/or in between any two of the preceding values.

In any embodiment herein, the composition may include from about 30 wt. % to about 70 wt. % of the UV curable resin dispersion, based on total weight of the composition. For example, in any embodiment herein, the composition may include from about 30 wt. % to about 70 wt. %, about 35 wt. % to about 65 wt. %, about 40 wt. % to about 60 wt. %, about 45 wt. % to about 55 wt. % of the UV curable resin dispersion, based on the total weight of the composition. Suitable amounts in any embodiment herein may include, but are not limited to, about 30 wt. %, about 35 wt. %, about 40 wt. %, about 45 wt. %, about 50 wt. %, about 55 wt. %, about 60 wt. %, about 65 wt. %, about 70 wt. %, or any range including and/or in between any two of the preceding values.

In any embodiment herein, the composition may be an energy curable composition that further includes one or more ethylenically unsaturated UV curable monomers or oligomers. In any embodiment herein, the one or more ethylenically unsaturated UV curable monomers or oligomers may be selected from Bisphenol A diglycidyl ether diacrylate, 2(2-ethoxyethoxy) ethyl acrylate, 2-phenoxyethyl acrylate, 2-phenoxyethyl methacrylate, C₁₂/C₁₄ alkyl methacrylate, C₁₆/C₁₈ alkyl acrylate, C₁₆/C₁₈ alkyl methacrylate, caprolactone acrylate, cyclic trimethylolpropane formal acrylate, ethoxylated (4) nonyl phenol acrylate, isobornyl acrylate, isobornyl methacrylate, isodecyl acrylate, lauryl acrylate, methoxy polyethylene glycol (350) monomethacrylate, octyldecyl acrylate, polypropylene glycol monomethacrylate, stearyl acrylate, tetrahydrofurfuryl acrylate, tetrahydrofurfuryl methacrylate, tridecyl acrylate, 1,3-butylene glycol dimethacrylate, 1,4-butanediol dimethacrylate, 1,6 hexanediol diacrylate, 1,6 hexanediol dimethacrylate, alkoxylated diacrylate, diethylene glycol dimethacrylate, dipropylene glycol diacrylate, esterdiol diacrylate, ethoxylated (10) bisphenol a diacrylate, ethoxylated (2) bisphenol a dimethacrylate, ethoxylated (3) bisphenol a diacrylate, ethoxylated (3) bisphenol a dimethacrylate, ethoxylated (4) bisphenol a diacrylate, ethoxylated (4) bisphenol a dimethacrylate, ethoxylated bisphenol a dimethacrylate, ethoxylated (10) bisphenol dimethacrylate, ethylene glycol dimethacrylate, polyethylene glycol (200) diacrylate polyethylene glycol (400) diacrylate, polyethylene glycol (400) dimethacrylate, polyethylene glycol (600) diacrylate, polyethylene glycol (600) dimethacrylate, polyethylene glycol 400 diacrylate, polyethylene glycol dimethacrylate, propoxylated (2) neopentyl glycol diacrylate, tetraethylene glycol diacrylate, tricyclodecane dimethanol diacrylate, tricyclodecanedimethanol dimethacrylate, triethylene glycol diacrylate, triethylene glycol dimethacrylate, tripropylene glycol diacrylate, ethoxylated (15) trimethylolpropane triacrylate, ethoxylated (3) trimethylolpropane triacrylate, ethoxylated (6) trimethylolpropane triacrylate, ethoxylated (9) trimethylolpropane triacrylate, ethoxylated 5 pentaerythritol triacrylate, ethoxylated (20) trimethylolpropane triacrylate, propoxylated (5.5) glyceryl triacrylate pentaerythritol triacrylate, propoxylated (3) glyceryl triacrylate, propoxylated (3) trimethylolpropane triacrylate, trimethylolpropane triacrylate, trimethylolpropane trimethacrylate, tris (2-hydroxy ethyl) isocyanurate triacrylate, di-trimethylolpropane tetraacrylate, dipentaerythritol pentaacrylate, and pentaerythritol tetraacrylate, or combinations of two or more thereof. In any embodiment herein, the one or more ethylenically unsaturated UV curable monomers or oligomers may be selected from ethoxylated (15) trimethylolpropane triacrylate, ethoxylated (3) trimethylolpropane triacrylate, ethoxylated (6) trimethylolpropane triacrylate, ethoxylated (9) trimethylolpropane triacrylate, Bisphenol A diglycidyl ether diacrylate, or a mixture of two or more thereof.

In any embodiment herein, the composition may include from about 5 wt. % to about 60 wt. % of the one or more ethylenically unsaturated UV curable monomer or oligomer, based on total weight of the composition. For example, in any embodiment herein, the composition may include from about 5 wt. % to about 60 wt. %, about 10 wt. % to about 50 wt. %, about 10 wt. % to about 40 wt. %, about 10 wt. % to about 20 wt. %, about 15 wt. % to about 35 wt. % of the one or more ethylenically unsaturated UV curable monomers or oligomers, based on the total weight of the composition. Suitable amounts in any embodiment herein may include, but are not limited to, about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, or any range including and/or in between any two of the preceding values.

The composition, as described in any embodiment herein, may further include a photoinitiator. Suitable photoinitiators in any embodiment herein may include, but are not limited to, an aryl ketone type photoinitiator (e.g., an acetophenone, a benzophenone, an alkylaminobenzophenone, a benzyl, a benzoin, a benzoin ether, a benzoin dimethyl ketal, a benzoyl benzoate, 1-hydroxycyclohexyl phenyl ketone or an a-acyloxime ester), a sulfur-containing photopolymerization initiator (e.g., a sulfide or a thioxanthone), an acylphosphine oxide (e.g., an acyldiarylphosphine oxide), or the like and mixtures of two or more thereof.

In any embodiment herein, the composition may include from about 0.1 wt. % to about 10 wt. % of the photoinitiator, based on total weight of the composition. For example, in any embodiment herein, the composition may include from about 0.1 wt. % to about 10 wt. %, about 0.5 wt. % to about 10 wt. %, about 1 wt. % to about 10 wt. %, about 1 wt. % to about 5 wt. % of the photoinitiator, based on the total weight of the composition. Suitable amounts in any embodiment herein may include, but are not limited to, about 0.01 wt. %, about 0.05 wt. %, about 0.1 wt. %, about 0.5 wt. %, about 1 wt. %, about 1.5 wt. %, about 2 wt. %, about 2.5 wt. %, about 3 wt. %, about 3.5 wt. %, about 4 wt. %, about 4.5 wt. %, about 5 wt. %, about 5.5 wt. %, about 6 wt. %, about 6.5 wt. %, about 7 wt. %, about 7.5 wt. %, about 8 wt. %, about 8.5 wt. %, about 9 wt. %, about 9.5 wt. %, about 10 wt. %, or any range including and/or in between any two of the preceding values.

In any embodiment herein, the composition may have a viscosity of about 5 cP to about 1000 cP. For example, in any embodiment herein, the viscosity may be about 5 cP to about 1000 cP, about 10 cP to about 50 cP, about 15 cP to about 30 cP, about 20 cP to about 25 cP, about 50 cP to about 1000 cP, about 300 cP to about 1000 cP, or about 600 cP to about 1000. Suitable amounts in any embodiment herein may include, but are not limited to, about 5 cP, about 10 cP, about 20 cP, about 30 cP, about 40 cP, about 50 cP, about 60 cP, about 70 cP, about 80 cP, about 90 cP, about 100 cP, about 150 cP, about 200 cP, about 250 cP, about 300 cP, about 350 cP, about 400 cP, about 450 cP, about 500 cP, about 550 cP, about 600 cP, about 650 cP, about 700 cP, about 750 cP, about 800 cP, about 850 cP, about 900 cP, about 950 cP, about 1000 cP, or any range including and/or in between any two of the preceding values. In any embodiment herein, the composition may have a viscosity of about 5 cP to about 45 cP, about 5 cP to about 35 cP, about 15 cP to about 25 cP. In any embodiment herein, the composition may have a viscosity of about 500 cP to about 900 cP or about 600 cP to about 800 cP.

The composition of the present technology, as described herein in any embodiment, may be configured for use in flexographic printing, ink jet printing, or three-dimensional (3D) printing.

In any embodiment herein, the composition may be UV curable.

### Method of Making

In one aspect, a method for producing a composition as described herein in any embodiment, where the method includes: combining the branched C₆-C₂₀ alkyl di-(meth)acrylate ester monomer and one or more non-white pigments to produce the UV curable resin dispersion; combining the UV curable resin dispersion with the one or more ethylenically unsaturated UV curable monomers or oligomers and optionally a photoinitiator.

In another aspect, a method for producing a composition as described herein in any embodiment herein, where the method includes: combining the branched C₆-C₂₀ alkyl di-(meth)acrylate ester monomer and the white pigment to produce the UV curable resin dispersion; combining the UV curable resin dispersion with the one or more ethylenically unsaturated UV curable monomers or oligomers and optionally a photoinitiator.

In any embodiment herein, the method for preparing the ink jet ink may further include controlling the temperature of the UV curable resin dispersion and/or composition with each combining step. For example, in any embodiment herein, the method may include controlling the temperature of the UV curable resin dispersion and/or composition to maintain a temperature from about 25° C. to about 80° C. Suitable temperatures in any embodiment herein may include, but are not limited to, about 25° C., about 30° C., about 35° C., about 40° C., about 45° C., about 50° C., about 55° C., about 60° C., about 65° C., about 70° C., about 75° C., about 80° C., or any range including and/or in between any two of the preceding values.

In any embodiment herein, the method may further include performing the combining steps where actinic radiation has been substantially excluded. As used herein, the term “actinic radiation” refers to radiation suitable for initiating light-activated cross-linking (i.e., curing) of the compositions as described herein in any embodiment. In any embodiment herein, “substantially excluded” as it relates to actinic radiation refers to filtering at least about 70% Transmission of radiation. For example, in any embodiment herein, substantially excluded actinic radiation may include, but is not limited to, filtering % Transmission of radiation by at least about 70%, at least about 75%, at least about 80%, at least about 85%, at least about 90%, at least about 91%, at least about 92%, at least about 93%, at least about 94%, at least about 95%, at least about 96% at least about 97%, at least about 98%, at least about 98.5%, at least about 99%, at least about 99.5%, at least about 99.9%, or any range including and/or in between any two of the preceding values. In any embodiment herein, the radiation may include light between about 200 nm to about 600 nm, about 200 nm to about 550 nm, about 200 nm to about 500 nm, 200 nm to about 450 nm, about 200 nm to about 400 nm, or any range including and/or in between any two of the preceding values.

In any embodiment herein, separate UV curable resin dispersions may be prepared, where each UV curable resin dispersion includes a different non-white or white pigment. For example, in any embodiment herein, the method may further include repeating the step of combining the branched C₆-C₂₀ alkyl di-(meth)acrylate ester monomer with a different non-white or white pigment to obtain the separate UV curable resin dispersions. In any embodiment herein, several non-white or white pigments (e.g., two or more) may be used in the step of combining the branched C₆-C₂₀ alkyl di-(meth)acrylate ester monomer and one or more non-white or white pigments.

The methods for preparing a composition as described herein in any embodiment may be directed to the preparation of a composition in the form of an ink jet ink composition. In any embodiment herein, the combining may further include combining a dispersant as described herein in any embodiment with the branched C₆-C₂₀ alkyl di-(meth)acrylate ester monomer and one or more non-white or white pigments. In any embodiment herein, combining the branched C₆-C₂₀ alkyl di-(meth)acrylate ester monomer, one or more non-white or white pigments, and optionally a dispersant may include mixing, precipitating, milling, or combinations thereof. In any embodiment herein, the mixing, precipitating, or milling may be performed using a ball mill, a pearl mill, a colloid mill, a high-speed disperser, a high-speed disperser, double rollers, a bead mill, a paint conditioner, triple rollers, ultrasonic energy, or combinations of two or more thereof. In any embodiment herein, the combining may be milling.

Milling, as described herein in any embodiment, may include use of milling (or grinding) media. Suitable milling media includes, but is not limited to, glasses, ceramics, metals, plastics, and combinations of any two or more thereof. For example, in any embodiment, the milling media may include particles having a spherical shape. In any embodiment herein, the particles having a spherical shape may be beads that include a polymeric resin, yttrium stabilized zirconium oxide, or combinations thereof.

In any embodiment herein, the milling may include mixing the C₆-C₂₀ branched alkyl di-(meth)acrylate ester monomer, the one or more non-white or white pigments, and dispersant with a milling media to obtain a milling mixture. In any embodiment herein, the milling mixture may further include additional UV curable resins to enable production of the ink in either of two stages, which may include a dispersion stage and a let down stage, or a single stage which may optionally include a photoinitiator as described herein in any embodiment. For example, the additional UV curable resins may employ an organic solvent. In any embodiment herein, the organic solvent may include, but is not limited to, alcohols, aromatic hydrocarbons, ketones, esters, aliphatic hydrocarbons, higher fatty acids, carbitols, cellosolves, higher fatty acid esters, or a combination of any two or more thereof. Suitable alcohols may include, but are not limited to, methanol, ethanol, propanol, 1-butanol, 1-pentanol, 2-butanol, t-butanol, or a mixture of any two or more thereof. Suitable aromatic hydrocarbons may include toluene, xylene, or a mixture thereof. Suitable ketones may include methyl ethyl ketone, methyl isobutyl ketone, 2,4-pentanedione, hexafluoroacetone, or a mixture of any two or more thereof. In any embodiment herein, the solvent may include, but is not limited to, glycol, glycolethers, N-methylpyrrolidone, N,N-dimethylacetamide, N,N-dimethylformamide, or a mixture of any two or more thereof. In any embodiment herein, the additional UV curable resins may employ one or more monomers or oligomers as described herein in any embodiment.

In any embodiment herein, the milling mixture may include from about 1 wt. % to about 50 wt. % of the non-white or white pigment based on the combined total weight of the C₆-C₂₀ branched alkyl di-(meth)acrylate ester monomer, non-white or white pigment, dispersant, and liquid carrier. For example, in any embodiment herein, the milling mixture may include about 1 wt. %, about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, or any range including and/or in between any two of the preceding values.

In any embodiment herein, the milling mixture may have a weight ratio of the non-white or white pigment to dispersant of about 20:1 to about 1:2. Suitable weight ratios may include, but are not limited to, about 20:1, about 15:1, about 10:1, about 5:1, about 3:1, about 1:1, about 1:2, or any range including and/or in between any two of the preceding values.

In any embodiment herein, the non-white or white pigment may have an average particle size of less than about 5 μm. For example, in any embodiment herein, the average particle size may be from about 200 nm to about 5 μm, about 200 nm to about 1 μm, about 200 nm to about 500 nm, about 210 nm to about 400 nm, about 220 nm to about 350 nm, or any range including and/or in between any two of the preceding values. Suitable average particle sizes in any embodiment herein may include, but are not limited to, about 5 μm, about 4 μm about 3 μm, about 2 μm, about 1 μm, about 950 nm, about 900 nm, about 850 nm, about 800 nm, about 750 nm, about 700 nm, about 650 nm, about 600 nm, about 550 nm, about 500 nm, about 450 nm, about 400 nm, about 350 nm, about 300 nm, about 250 nm, about 200 nm, about 150 nm, or any range including and/or in between any two of the preceding values.

In any embodiment herein, the milling may further include separating the milling mixture to remove the milling media and obtain the UV curable resin dispersion. For example, in any embodiment herein, the separating may include, but is not limited to, filtration, sieving through a mesh screen, or the like or combinations thereof.

In any embodiment herein, the milling may be carried out in a continuous mode, batch mode, or semi-batch mode.

In a related aspect, an article is provided that includes one or more coatings of a cured energy curable composition. The cured energy curable composition may include an energy curable composition as described herein in any embodiment that has undergone irradiation with UV irradiation.

In another aspect, a method of obtaining said article is provided comprising applying one or more successive layers of the energy curable composition as described herein in any embodiment to fabricate the article; and irradiating the successive layers with UV irradiation. In any embodiment herein, the applying may include depositing a first layer of the energy curable composition to a substrate and applying a second layer of the energy curable composition to the first layer and applying successive layers thereafter. In any embodiment herein, the UV radiation may include a wavelength of about 185 nm to about 450 nm. In any embodiment, the UV irradiating may be conducted for less than about 0.5 seconds. In any embodiment, the UV irradiating may be conducted for less than about 0.4 seconds, less than about 0.3 seconds, less than about 0.25 seconds, or any range including and/or in between any two of the preceding values. In any embodiment herein, the UV irradiating may be conducted for about 0.1 seconds to about 0.3 seconds.

In another related aspect, a 3D article is provided that includes a cured energy curable composition as described herein in any embodiment. In any embodiment herein, the 3D article may include successive layers of the cured energy curable composition.

In another aspect, a method of obtaining said 3D article is provided that includes applying one or more successive layers of the energy curable composition as described herein in any embodiment to fabricate the 3D article; and irradiating the successive layers with UV irradiation.

The method of obtaining said 3D article may include various types of 3D printing methods as described herein in any embodiment. In any embodiment herein, the applying may include depositing a first layer of the energy curable composition to a substrate and applying a second layer of the energy curable composition to the first layer and applying successive layers thereafter. In any embodiment herein, the UV radiation may include a wavelength of about 185 nm to about 450 nm. In any embodiment, the UV irradiating may be conducted for less than about 0.5 seconds. In any embodiment, the UV irradiating may be conducted for less than about 0.4 seconds, less than about 0.3 seconds, less than about 0.25 seconds, or any range including and/or in between any two of the preceding values. In any embodiment herein, the UV irradiating may be conducted for about 0.1 seconds to about 0.3 seconds.

The present technology, thus generally described, will be understood more readily by reference to the following examples, which are provided by way of illustration and are not intended to be limiting of the present technology.

### EXAMPLES

Example 1: Preparation of Pigment Dispersion: Exemplary pigment dispersions were prepared according to the present technology described herein in any embodiment. As shown in Table 1, a pigment dispersion was prepared by di-(meth)acrylate ester of hydroxypivalic acid neopentyl glycol ester (“Monomer X”), a high molecular weight dispersant, ethoxylated trimethylolpropane triacrylate (EOTMPTA), and a pigment. Comparative pigment dispersions A and B were prepared as described above, but included polyester A (polyester based on glycerol propoxylate triacrylate and pentaerythritol) or polyester B (polyester based on EOTMPTA, adipic acid, and acrylic acid; MW 940).

TABLE 1
Pigment Dispersions

| | Pigment Dispersion Samples | | |
|---|---|---|---|
| Component (wt. %) | 1 | A | B |
| Monomer X | 35 | — | — |
| Polyester A | — | 67.4 | — |
| Polyester B | — | — | 45.1 |
| EOTMPTA | — | — | 22.3 |
| High MW dispersant | 5 | 2.6 | 2.6 |
| Pigment | 60 | 30 | 30 |

### Example 2: Preparation and Evaluation of Ink Compositions

TABLE 2
Ink Compositions

| | Sample Inks | | |
|---|---|---|---|
| Component (wt. %) | 1 | A | B |
| Dispersion 1 | 50 | — | — |
| Dispersion A | — | 50 | — |
| Dispersion B | — | — | 50 |
| EOTMPTA | 20 | 20 | 16.7 |
| Laromer LR 8986 | 20 | 20 | 23.3 |
| photoinitiator blend | 10 | 10 | 10 |

TABLE 3
Ink Properties

| Property | Substrate | Ink 1 | Ink A | Ink B |
|---|---|---|---|---|
| % Pigment | | 30 | 15 | 15 |
| Cure Dose (mJ/m²) | | 224 | 126 | 126 |
| Color Density | Leneta (w) | 2.5 | 1.6 | 1.7 |
| | Leneta (b) | 2.1 | 2.3 | 2.3 |
| | PET | 2.5 | 1.9 | 2.0 |
| | OPP | 2.6 | 1.4 | Dewet |
| Gloss 60° (1.8 μm film) | Leneta (w) | 51.1 | 51.5 | 50.4 |
| | Leneta (b) | 52.0 | 55.5 | 46.5 |
| | PET | 76.3 | 112 | 112 |
| | OPP | 59.2 | 71.2 | Dewet |
| Adhesion (% remain) | PET | 100 | 100 | 100 |
| | OPP | 100 | 100 | 100 |

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1.-63. (canceled)

64. A composition comprising:
a UV curable resin dispersion comprising a branched C₆-C₂₀ alkyl di-(meth)acrylate ester monomer and one or more non-white pigments;
wherein the composition comprises at least about 15 wt. % of the non-white pigment, based on total weight of the composition.

65. The composition of claim 64, wherein the alkyl di-(meth)acrylate ester monomer is a branched C₆-C₁₅ alkyl di-(meth)acrylate ester monomer.

66. The composition of claim 64, wherein the branched alkyl di-(meth)acrylate ester monomer is a branched C₉-C₁₁ alkyl di-(meth)acrylate ester monomer.

67. The composition of claim 64, wherein the branched alkyl di-(meth)acrylate ester monomer is a di-(meth)acrylate ester of hydroxypivalic acid neopentyl glycol ester.

68. The composition of claim 64, wherein the UV curable resin dispersion comprises at least 10 wt. % of the branched C₆-C₂₀ alkyl di-(meth)acrylate ester monomer, based on total weight of the UV curable resin dispersion.

69. The composition of claim 64, wherein the UV curable resin dispersion comprises about 10 wt. % to about 50 wt. % of the branched C₆-C₂₀ alkyl di-(meth)acrylate ester monomer, based on total weight of the UV curable resin dispersion.

70. The composition of claim 69, wherein the UV curable resin dispersion comprises about 25 wt. % to about 35 wt. % of the branched C₆-C₂₀ alkyl di-(meth)acrylate ester monomer, based on total weight of the UV curable resin dispersion.

71. The composition of claim 64, wherein the UV curable resin dispersion comprises from about 35 wt. % to about 65 wt. % of the one or more non-white pigment, based on total weight of the UV curable resin dispersion.

72. The composition of claim 71, wherein the UV curable resin dispersion comprises from about 40 wt. % to about 60 wt. % of the one or more non-white pigment, based on total weight of the UV curable resin dispersion.

73. The composition of claim 64, wherein the UV curable resin dispersion further comprises a dispersant having a molecular weight (M_{w}) of at least about 5,000.

74. The composition of claim 73, wherein the dispersant has a molecular weight from about 100 g/mol to about 5,000,000 g/mol.

75. The composition of claim 73, wherein the UV curable resin dispersion comprises about 0.01 wt. % to about 10 wt. % of the dispersant, based on total weight of the UV curable resin dispersion.

76. The composition of claim 73, wherein the UV curable resin dispersion comprises about 1 wt. % to about 6 wt. % of the dispersant, based on total weight of the UV curable resin dispersion.

77. The composition of claim 73, wherein the UV curable resin dispersion comprises about 2.5 wt. % to about 5.5 wt. % of the dispersant, based on total weight of the UV curable resin dispersion.

78. The composition of claim 64, wherein the composition comprises about 30 wt. % to about 70 wt. % of the UV curable resin dispersion, based on total weight of the composition.

79. The composition of claim 64, wherein the composition is an energy curable composition and further comprises one or more ethylenically unsaturated UV curable monomers or oligomers.

80. The composition of claim 79, wherein the one or more ethylenically unsaturated UV curable monomers or oligomers comprises ethoxylated trimethylolpropane tri(meth)acrylate, Bisphenol A diglycidyl ether diacrylate, 2(2-ethoxyethoxy) ethyl acrylate, 2-phenoxyethyl acrylate, 2-phenoxyethyl methacrylate, C₁₂/C₁₄ alkyl methacrylate, C₁₆/C₁₈ alkyl acrylate, C₁₆/C₁₈ alkyl methacrylate, caprolactone acrylate, cyclic trimethylolpropane formal acrylate, ethoxylated (4) nonyl phenol acrylate, isobornyl acrylate, isobornyl methacrylate, isodecyl acrylate, lauryl acrylate, methoxy polyethylene glycol (350) monomethacrylate, octyldecyl acrylate, polypropylene glycol monomethacrylate, stearyl acrylate, tetrahydrofurfuryl acrylate, tetrahydrofurfuryl methacrylate, tridecyl acrylate, 1,3-butylene glycol dimethacrylate, 1,4-butanediol dimethacrylate, 1,6 hexanediol diacrylate, 1,6 hexanediol dimethacrylate, alkoxylated diacrylate, diethylene glycol dimethacrylate, dipropylene glycol diacrylate, esterdiol diacrylate, ethoxylated (10) bisphenol a diacrylate, ethoxylated (2) bisphenol a dimethacrylate, ethoxylated (3) bisphenol a diacrylate, ethoxylated (3) bisphenol a dimethacrylate, ethoxylated (4) bisphenol a diacrylate, ethoxylated (4) bisphenol a dimethacrylate, ethoxylated bisphenol a dimethacrylate, ethoxylated (10) bisphenol dimethacrylate, ethylene glycol dimethacrylate, polyethylene glycol (200) diacrylate polyethylene glycol (400) diacrylate, polyethylene glycol (400) dimethacrylate, polyethylene glycol (600) diacrylate, polyethylene glycol (600) dimethacrylate, polyethylene glycol 400 diacrylate, polyethylene glycol dimethacrylate, propoxylated (2) neopentyl glycol diacrylate, tetraethylene glycol diacrylate, tricyclodecane dimethanol diacrylate, tricyclodecanedimethanol dimethacrylate, triethylene glycol diacrylate, triethylene glycol dimethacrylate, tripropylene glycol diacrylate, ethoxylated (15) trimethylolpropane triacrylate, ethoxylated (3) trimethylolpropane triacrylate, ethoxylated (6) trimethylolpropane triacrylate, ethoxylated (9) trimethylolpropane triacrylate, ethoxylated 5 pentaerythritol triacrylate, ethoxylated (20) trimethylolpropane triacrylate, propoxylated (5.5) glyceryl triacrylate pentaerythritol triacrylate, propoxylated (3) glyceryl triacrylate, propoxylated (3) trimethylolpropane triacrylate, trimethylolpropane triacrylate, trimethylolpropane trimethacrylate, tris (2-hydroxy ethyl) isocyanurate triacrylate, di-trimethylolpropane tetraacrylate, dipentaerythritol pentaacrylate, and pentaerythritol tetraacrylate, or combinations of two or more thereof.

81. The composition of claim 79, wherein the composition comprises about 5 wt. % to about 60 wt. % of the one or more ethylenically unsaturated UV curable monomer or oligomer, based on total weight of the composition.

82. The composition of claim 64, wherein the composition further comprises a photoinitiator.

83. The composition of claim 82, wherein the photoinitiator is selected from the group consisting of an aryl ketone type photoinitiator, a sulfur-containing photopolymerization initiator, an acylphosphine oxide, and the like and mixtures of two or more thereof.
